(19) United States
(12) Patent Application Publication
(10) Pub. No.: US 2018/0216397 A1
(43) Pub. Date: Aug. 2, 2018

(54) INWARD-OPENING TYPE CASEMENT WINDOW HAVING OUTWARD-OPENING PANE AND SCREEN, AND HANDLE LOCK AND HINGE USED THEREFOR

(71) Applicant: Qiwu Chen, Xiamen (CN)

(72) Inventor: Qiwu Chen, Xiamen (CN)

(21) Appl. No.: 15/747,150

(22) PCT Filed: Sep. 30, 2015
(86) PCT No.: PCT/CN2015/091227

§ 371 Date: Jan. 24, 2018

(51) Int. Cl. E06B 3/36; E06B 5/00; E06B 9/52; E05D 15/30; E05D 15/54

(52) U.S. Cl. CPC E06B 3/36; E06B 5/003; E06B 9/52; E05D 15/30; E05D 15/54; E06B 2003/346; E05Y 2800/102; E05Y 2800/744; E05Y 2900/146; E05Y 2900/148; E05Y 2201/68

(57) ABSTRACT

An inward-opening type casement window having outward-opening pane and screen is provided. A primary screen is installed, via a first hinge, in a primary casement window frame so as to open inwardly. The primary screen is formed with a secondary frame. A secondary pane is installed, via a second hinge, in the secondary frame so as to open outwardly. A handle lock is installed between the primary screen and the primary casement window frame and between the secondary pane and the secondary frame. The handle lock is used to control opening and closing of the primary screen and the secondary pane. The pane can be swung out to facilitate ventilation, and the screen can prevent entry of insects and burglars. Moreover, the pane can be swung in together with the screen, thereby facilitating access, ventilation and cleansing.

### BACKGROUND OF THE INVENTION

### 1. Field of the Invention

The present invention relates to a window, and more particularly to an inward-opening type casement window having outward-opening pane and screen, and a dual-control single-handle handle lock used for the casement window, and a novel friction hinge.

### 2. Description of the Prior Art

Doors and windows are not only an important part of the building system, but also an important component of the building shape. Moreover, the doors and windows also have the functions of thermal preservation, heat insulation, sound insulation, waterproof, fire prevention, ventilation, mosquito prevention and anti-theft. The windows and doors are classified according to their opening ways, which are classified into fixed windows, top-hung windows, middle-hung windows, bottom-hung windows, turning windows, side-hung windows, sliding side-hung windows, sliding windows, side-hung bottom-hung window, push and pull windows, push and pull side-hung windows, folding doors, doors having floor springs, push and pull doors, push and pull folding doors, and inward-push sliding doors. Side-hung doors and windows can be classified into inward-opening doors and windows and outward-opening doors and windows.

In order to increase the mosquito prevention function in the ventilation situation, the industry improves the conventional side-hung doors and windows. The conventional glass door or window is installed with a screen to enhance the use function of the window and door. However, in the prior art, there are various opening structures for side-hung doors and windows having screens. The features of various structures are also different. The inventor analyzed and researched and summarized as follows.

1. The advantage of the existing outward-opening window is that the glass sash is opened outwardly, which can facilitate ventilation and does not occupy the indoor space. The glass sash is located at the outdoor side, maintaining the aesthetics of the building. The drawback is that the outward-opening glass sash may fall and that it is inconvenient and not safe to wash the outside of the glass sash. A hidden screen is installed at the inner side of the window. The service life of the hidden screen is short and the operation is inconvenient.

2. The advantage of the existing inward-opening window is that the glass sash is opened inwardly, which is convenient and safe for washing. There is no need to worry about the falling of the window. The drawback is that it occupies the indoor space. The screen is generally a hidden screen or externally fixed screen or removable screen. The screen is installed at the outdoor side, and its service life is shorter. The screen at the outdoor side may affect the appearance of the building.

3. As to the existing two-layer window, the inner layer is a window screen and the outer layer is a glass panel. It can facilitate ventilation and does not occupy the indoor space. The glass sash is located at the outdoor side, maintaining the aesthetics of the building. The screen is opened in a side-hung manner and has a long service life. The screen may use an economy practical plastic screen having an anti-mosquito function. The screen may use a stainless steel screen having an anti-mosquito anti-theft function. The disadvantage is that it is inconvenient and not safe to wash the glass. The outward-opening glass sash may fall and the manufacture cost is high.

4. As to the existing two-layer window, the inner layer is a glass panel and the outer layer is a window screen. It is convenient and safe for washing. There is no need to worry about the falling of the window. The screen is opened in a side-hung manner and has a long service life. The screen may use an economy practical plastic screen having an anti-mosquito function. The screen may use a stainless steel screen having an anti-mosquito anti-theft function. The drawback is that it occupies the indoor space. The screen at the outdoor side may affect the appearance of the building. The manufacture cost is high.

5. As to the existing two-layer window, the glass sash of the inner layer is opened inwardly and the window screen of the outer layer is opened outwardly, alternatively, the window screen of the inner layer is opened inwardly and the glass sash of the outer layer is opened outwardly. The drawback is that the outer metal handle is generally hidden or a low handle and unfavorable for operation. The screen at the outdoor side may affect the appearance of the building. It is inconvenient and not safe to wash the outside of the glass sash. The manufacture cost is high

6. As to the existing integral casement window having pane and screen, the primary screen is located at the outer side and opened outwardly, and the secondary pane is located at the inner side and opened inwardly. The primary screen can drive the secondary pane to be opened outwardly. It is convenient and safe for washing. There is no need to worry about the falling of the window. The screen is opened in a side-hung manner and has a long service life. The screen may use an economy practical plastic screen having an anti-mosquito function. The screen may use a stainless steel screen having an anti-mosquito anti-theft function. The drawback is that it occupies the indoor space. The window has two handles, which is not pleasing to the eyes. The screen at the outdoor side may affect the appearance of the building.

### SUMMARY OF THE INVENTION

The primary object of the present invention is to provide an inward-opening type casement window having outward-opening pane and screen. The pane can be swung out to facilitate ventilation, and the screen can prevent entry of insects and burglars. Moreover, the pane can be swung in together with the screen, thereby facilitating access, ventilation and cleansing.

Another object of the present invention is to provide a dual-control single-handle handle lock to achieve a dual-control function with a single handle to open the screen and the pane, providing an integral high-performance window with a single handle control.

A further object of the present invention is to provide a novel friction hinge to ensure that the secondary pane in an open state to be opened outwardly upon closing of the primary screen.

A further object of the present invention is to provide a section with a number of advantages and a more reliable function.

According to one aspect of the present invention, an inward-opening type casement window having outward-opening pane and screen is provided. The casement window comprises a primary casement window frame, a primary screen, a secondary pane, and a handle lock. The primary screen is installed in the primary casement window frame via a first hinge so as to open inwardly. The primary screen is formed with a secondary frame. The secondary pane is installed in the secondary frame via a second hinge so as to open outwardly. The handle lock is installed between the primary screen and the primary casement window frame and between the secondary pane and the secondary frame. The handle lock is used to control opening and closing of the primary screen and the secondary pane, thereby enabling the entire casement window to be closed, or the secondary pane to be opened inwardly along with the primary screen, or the secondary pane to be separated from the primary screen and opened outwardly, or the secondary pane in an open state to be opened outwardly upon closing of the primary screen.

Preferably, the handle lock is a double-control single-handle handle lock. The handle lock has a handle, a transmission shaft, two transmission rods, a first locking point, and a second locking point. The handle is mounted at an inner side of the primary screen. The transmission shaft and the transmission rods are mounted on the primary screen. The handle drives the transmission rods to slide up and down through the transmission shaft. The first locking point is fixed to one side of one of the transmission rods close to the primary casement window frame. The first locking point extends beyond the primary screen. The primary casement window frame is provided with a first locking block. The first locking block cooperates with the first locking point to lock or unlock the primary screen. The second locking point is fixed to one side of the other transmission rod close to the secondary frame. The second locking point extends beyond the secondary frame. The secondary pane is provided with a second locking block. The second locking block cooperates with the second locking point to lock or unlock the secondary pane. When the handle is not rotated, the first locking point and the second locking point are locked. When the handle is rotated leftward or rightward, the first locking point is driven to unlock but the second locking point remains locked or the second locking point and the first locking point are unlocked.

Alternatively, the handle lock has a single-control single-handle primary lock and a single-control single-handle secondary lock. The primary lock and the secondary lock each have a handle, a transmission shaft, a transmission rod, and a first locking point or a second locking point. The handles of the primary lock and the secondary lock are mounted at an inner side of the primary screen and arranged at a high position and a lower position, respectively. The two transmission shafts and the two transmission rods of the primary lock and the secondary lock are correspondingly installed on the primary screen. The handle drives the corresponding transmission rod to slide up and down through the corresponding transmission shaft. The first locking point is fixed to one side of the transmission rod of the primary lock close to the primary casement window frame. The first locking point extends beyond the primary screen. The primary casement window frame is provided with a first locking block. The first locking block cooperates with the first locking point to lock or unlock the primary screen. The second locking point is fixed to one side of the transmission rod of the secondary lock close to the secondary frame. The second locking point extends beyond the secondary frame. The secondary pane is provided with a second locking block. The second locking block cooperates with the second locking point to lock or unlock the secondary pane. When the two handles of the primary lock and the secondary lock are not rotated, the first locking point and the second locking point are locked. When the handle of the primary lock or the handle of the secondary lock is rotated leftward or rightward, the first locking point or the second locking point is driven to unlock.

Or, the handle lock has a single-control single-handle primary lock and a single-control single-handle secondary lock, the primary lock and the secondary lock each have a handle, a transmission shaft, a transmission rod, and a first locking point or a second locking point. The handle of the primary lock is installed at an inner side of the primary screen. The transmission shaft and the transmission rod of the primary lock are correspondingly installed on the primary screen. The handle of the primary lock drives the corresponding transmission rod to slide up and down through the corresponding transmission shaft. The first locking point is fixed to one side of the transmission rod of the primary lock close to the primary casement window frame. The first locking point extends beyond the primary screen. The primary casement window frame is provided with a first locking block. The first locking block cooperates with the first locking point to lock or unlock the primary screen. The handle of the secondary lock is installed at an outer side of the secondary pane. The transmission shaft and the transmission rod of the secondary lock are correspondingly mounted on the secondary pane. The handle drives the corresponding transmission rod to slide up and down through the corresponding transmission shaft. The second locking point is fixed to one side of the transmission rod of the secondary lock close to the secondary frame. The second locking point extends beyond the secondary pane. The secondary frame is provided with a second locking block. The second locking block cooperates with the second locking point to lock or unlock the secondary pane. When the two handles of the primary lock and the secondary lock are not rotated, the first locking point and the second locking point are locked. When the handle of the primary lock or the handle of the secondary lock is rotated leftward or rightward, the first locking point or the second locking point is driven to unlock.

Or, the handle lock has a single-control single-handle primary lock and a single-control single-handle secondary lock. The primary lock and the secondary lock each have a handle, a transmission shaft, a transmission rod, and a first locking point or a second locking point. The handle of the primary lock is installed at an inner side of the primary casement window frame. The transmission shaft and the transmission rod of the primary lock are correspondingly installed on the primary casement window frame. The handle of the primary lock drives the corresponding transmission rod to slide up and down through the corresponding transmission shaft. The first locking point is fixed to one side of the transmission rod of the primary lock close to the primary screen. The first locking point extends beyond the primary casement window frame. The primary screen is provided with a first locking block. The first locking block cooperates with the first locking point to lock or unlock the primary screen. The handle of the secondary lock is installed at an inner side of the primary screen. The transmission shaft and the transmission rod of the secondary lock are correspondingly mounted on the primary screen. The handle of the secondary lock drives the corresponding transmission rod to slide up and down through the corresponding transmission shaft. The second locking point is fixed to one side of the transmission rod of the secondary lock close to the secondary frame. The second locking point extends beyond the primary screen. The secondary pane is provided with a second locking block. The second locking block cooperates with the second locking point to lock or unlock the secondary pane. When the two handles of the primary lock and the secondary lock are not rotated, the first locking point and the second locking point are locked. When the handle of the primary lock or the handle of the secondary lock is rotated leftward or rightward, the first locking point or the second locking point is driven to unlock.

Preferably, the primary screen has a T shape which is integrally formed or compositely formed. The primary screen has a primary horizontal frame, a primary vertical frame, and a stop flange. The primary horizontal frame is located at an inner end of the primary vertical frame. A corner between the primary horizontal frame and the primary vertical frame is formed with the secondary frame for mounting the secondary pane in an outward-opening manner. An inner side of the primary horizontal frame is a screen mounting surface. The screen mounting surface is provided with an engaging strip. An inner side of the primary vertical frame is formed with a handle mounting portion. The inner end of the primary vertical frame extends in a direction opposite to the primary horizontal frame to form the stop flange of the primary screen to cooperate with the primary casement window frame. The primary vertical frame has a chamber for mounting the transmission shaft and the transmission rod of the handle lock. One side surface of the primary vertical frame, close to the primary casement window frame, and another side surface of the primary vertical frame, close to the secondary frame, are formed with mounting troughs for mounting the first and second locking points or the first and second locking blocks, respectively. The side surface of the primary vertical frame, close to the primary casement window frame, is further formed with another stop flange to cooperate with a sealing strip of the primary casement window frame.

Preferably, the first locking point and the first locking block each have two or more. The first locking points correspond to the first locking blocks one by one. The second locking point and the second locking block each have two or more. The second locking points correspond to the second locking blocks one by one.

Preferably, the first hinge is a butt hinge or a pie-cut corner hinge. The second hinge is a butt hinge, a pie-cut corner hinge or a novel friction hinge.

Preferably, the second hinge is a novel friction hinge. The second hinge has a hinge seat, a mounting rod, a fixing block, a slider, a first linkage rod, a second linkage rod and a third linkage rod, the hinge seat is mounted on the secondary frame, a head end of the hinge seat abuts against a non-opening end of the secondary frame, the fixing block is fixed in the hinge seat and is located at a position close to the head end of the hinge seat, the slider is slidably disposed at a distal end of the hinge seat, the mounting rod is mounted on the secondary pane, one end of each of the first linkage rod and the second linkage rod is pivotally connected to the fixing block, one end of the third linkage rod is pivotally connected to the slider, another end of the first linkage rod is pivotally connected to a head end of the mounting rod, and another end of the second linkage rod is pivotally connected to a middle of the third linkage rod, another end of the third linkage rod is pivotally connected to a middle of the mounting rod.

The primary casement window frame, the primary screen and the secondary pane is made of aluminum alloy, plastics, wood, steel, glass fiber reinforced plastics (FRP) or a composite thereof. The primary screen is made of plastics, stainless steel or other material.

According to another aspect of the present invention, a double-control single-handle handle lock is provided. The double-control single-handle handle lock comprises a handle, a transmission shaft, two transmission rods, a first locking point, and a second locking point. The handle is mounted at an inner side of a primary screen. The transmission shaft and the transmission rods are mounted on the primary screen. The handle drives the transmission rods to slide up and down through the transmission shaft. The first locking point is fixed to one side of one of the transmission rods close to a primary casement window frame. The first locking point extends beyond the primary screen. The primary casement window frame is provided with a first locking block. The first locking block cooperates with the first locking point to lock or unlock the primary screen. The second locking point is fixed to one side of the other transmission rod close to a secondary frame. The second locking point extends beyond the secondary frame. A secondary pane is provided with a second locking block. The second locking block cooperates with the second locking point to lock or unlock the secondary pane. When the handle is not rotated, the first locking point and the second locking point are locked. When the handle is rotated leftward or rightward, the first locking point is driven to unlock but the second locking point remains locked or the second locking point and the first locking point are unlocked.

According to another aspect of the present invention, a novel friction hinge is provided. The novel friction hinge comprises a hinge seat, a mounting rod, a fixing block, a slider, a first linkage rod, a second linkage rod, and a third linkage rod. The hinge seat is mounted on a secondary frame. The head end of the hinge seat abuts against a non-opening end of the secondary frame. The fixing block is fixed in the hinge seat and located at a position close to the head end of the hinge seat. The slider is slidably disposed at a distal end of the hinge seat. The mounting rod is mounted on a secondary pane. One end of each of the first linkage rod and the second linkage rod is pivotally connected to the fixing block. One end of the third linkage rod is pivotally connected to the slider. Another end of the first linkage rod is pivotally connected to a head end of the mounting rod. Another end of the second linkage rod is pivotally connected to a middle of the third linkage rod. Another end of the third linkage rod is pivotally connected to a middle of the mounting rod.

After adopting the above scheme, the primary screen of the present invention is opened inwardly, and the secondary pane is opened outwardly. The pane can be swung out to facilitate ventilation, and the screen can prevent entry of insects and burglars. Moreover, the pane can be swung in together with the screen, thereby facilitating access, ventilation and cleansing.

Furthermore, the invention uses a single handle to control the opening of the primary screen and the secondary pane to form an integrated dual-control high-performance window.

The advantages of the present invention are:

1. The present invention takes into account the advantages of outward-opening windows and inward-opening window, that is, the present invention facilitates ventilation and prevents entry of insects and doesn't occupy indoor space. The glass is disposed at the outdoor side to maintenance the aesthetic appearance of the building. It is easy and safe to wash glass. The present invention can prevent the glass pane from falling.

2. The present invention takes into account the advantages of the conventional two-layer window (regardless of inward-opening or outward-opening) and doesn't occupy indoor space. The glass is disposed at the outdoor side to maintenance the aesthetic appearance of the building. The screen is disposed in a side-hung manner, has a long service life, and can prevent entry of insects and burglars. The glass pane won't fall and can be washed conveniently and safely.

3. The present invention solves the problems of the conventional two-layer window (regardless of inward-opening or outward-opening) that the outer metal handle is generally hidden or a low handle and unfavorable for operation and has a high manufacture cost.

4. In the novel friction hinge, the head end of the hinge seat abuts against the non-opening end of the secondary frame. The fixing block of the hinge is disposed at a position close to the head end of the hinge seat. The slider is slidably disposed at the distal end of the hinge seat. When the primary screen is opened inwardly and the secondary pane is opened at the maximum angle and the primary screen fan is closed again, the opened secondary pane will be turned from the inside to the outside and won't interfere with the primary casement window frame to ensure that the secondary pane can be opened for ventilation and the primary screen is in a closed state to prevent entry of insects and burglars.

5. The section structure of the novel primary screen has the advantages of mosquito-resisting windows, anti-theft windows, inward-opening windows, and outward-opening windows, and solves their respective shortcomings and deficiencies, and ensures the use of the respective window sashes. This novel section structure has innovative breakthrough significances for windows.

### BRIEF DESCRIPTION OF THE DRAWINGS

FIG. 1 is a schematic view of the entire casement window (the primary screen and the secondary pane) in a closed state of the present invention;

FIG. 2 is a schematic view of the entire casement window (the primary screen and the secondary pane) to be opened inwardly of the present invention;

FIG. 3 is a first schematic view of the present invention, showing that the primary screen is opened inwardly and the secondary pane is opened;

FIG. 4 is a second schematic view of the present invention, showing that the primary screen is opened inwardly and the secondary pane is opened;

FIG. 5 is a schematic view of the present invention, showing that the primary screen is closed and the secondary pane is opened outwardly;

FIG. 6 is a schematic view of the handle lock of the present invention when the entire casement window is closed;

FIG. 7 is a schematic view of the handle lock of the present invention when the primary screen is opened;

FIG. 8 is a schematic view of the handle lock of the present invention when the secondary pane is opened;

FIG. 9 is a schematic view of the novel friction hinge of the present invention (in a semi-open state);

FIG. 10 is a schematic view of the novel friction hinge of the present invention (in a full-open state);

FIG. 11 is a schematic view of the conventional friction hinge (in a semi-open state);

FIG. 12 is a schematic view of the conventional friction hinge (in a full-open state);

FIG. 13 is an enlarged view of the section of the primary screen of the present invention (a partial enlarged view of FIG. 3);

FIG. 14 is an enlarged view of the section of the secondary pane of the present invention (a partial enlarged view of FIG. 3);

FIG. 15 is a first sectional view of another embodiment of the handle lock of the present invention;

FIG. 16 is a second sectional view of another embodiment of the handle lock of the present invention;

FIG. 17 is a sectional view of a further embodiment of the handle lock of the present invention; and

FIG. 18 is a sectional view of a yet another embodiment of the handle lock of the present invention.

### DETAILED DESCRIPTION OF THE PREFERRED EMBODIMENTS

Embodiments of the present invention will now be described, by way of example only, with reference to the accompanying drawings.

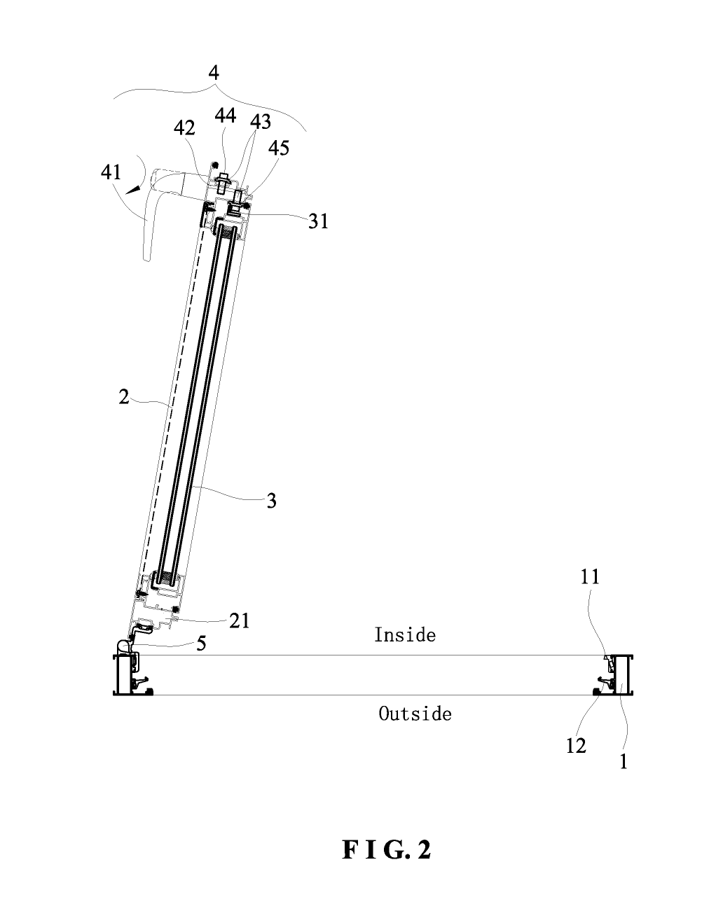

As shown in FIG. 2 to FIG. 6, the present invention discloses an inward-opening type casement window having outward-opening pane and screen, comprising a primary casement window frame 1, a primary screen 2, a secondary pane 3, and a handle lock 4.

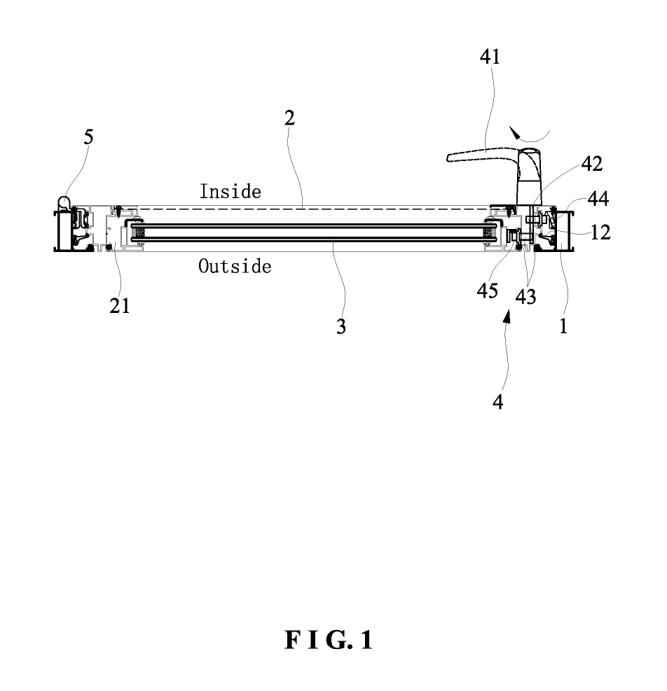

The first feature of the present invention is that the primary screen 2 is installed in the primary casement window frame 1 via a first hinge 5 so as to open inwardly. The first hinge 5 may be a butt hinge (see FIG. 1 to FIG. 5) or a pie-cut corner hinge. The primary screen 2 is formed with a secondary frame 21. The secondary pane 3 is installed in the secondary frame 21 via a second hinge 6 so as to open outwardly. The second hinge 6 may be a butt hinge, a pie-cut corner hinge, or a novel hinge. The primary casement window frame 1, the primary screen 2 and the secondary pane 3 may be made of aluminum alloy, plastics, wood, steel, glass fiber reinforced plastics (FRP), or a composite thereof according to the design requirements. The screen may be made of plastics, stainless steel, or other materials according to the needs. The handle lock 4 is installed between the primary screen 2 and the primary casement window frame 1 and between the secondary pane 3 and the secondary frame 21. The handle locks 4 are used to control opening and closing of the primary screen 2 and the secondary pane 3, thereby enabling the entire casement window (the primary screen 2 and the secondary pane 3) to be closed, or the secondary pane 3 to be opened inwardly along with the primary screen 2, or the secondary pane 3 to be separated from the primary screen 2 and opened outwardly, or the secondary pane 3 in an open state to be opened outwardly upon closing of the primary screen 2.

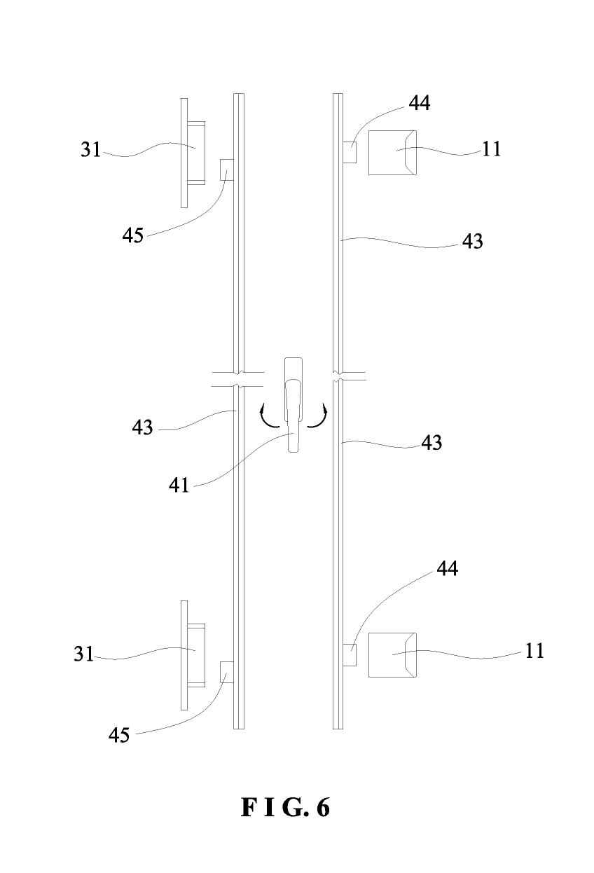

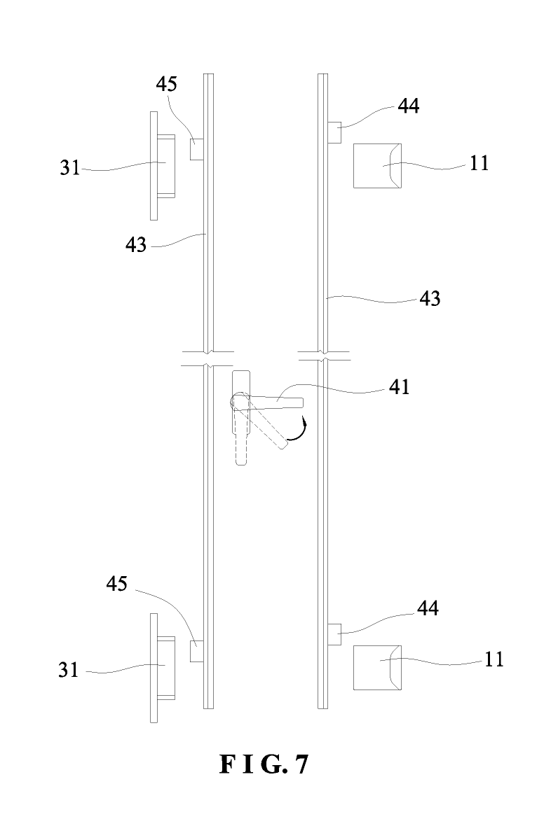

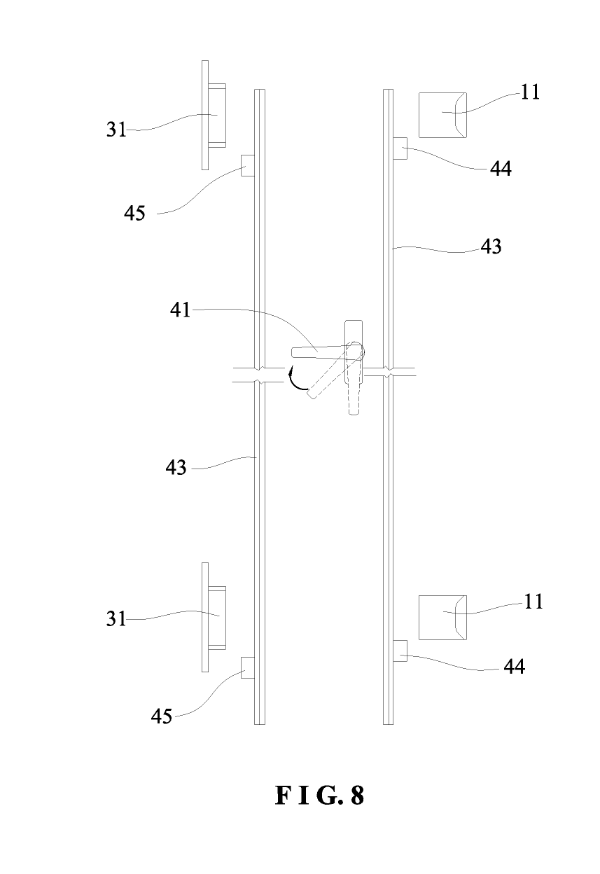

Another feature of the present invention is that the handle lock 4 is a double-control single-handle handle lock. As shown in FIG. 6 to FIG. 8, the handle lock 4 has a handle 41, a transmission shaft 42, two transmission rods 43, a first locking point 44 and a second locking point 45. The handle 41 is mounted at the inner side of the primary screen 2. The transmission shaft 42 and the transmission rods 43 are mounted on the primary screen 2. The handle 41 drives the transmission rods 43 to slide up and down through the transmission shaft 42. The first locking point 44 is fixed to one side of one of the transmission rods 43 close to the primary casement window frame 1. The first locking point 44 extends beyond the primary screen 2. The primary casement window frame 1 is provided with a first locking block 11. The first locking block 11 cooperates with the first locking point 44 to lock or unlock the primary screen 2. In order to make the locked position more stable when the primary screen 2 is closed, this embodiment has two first locking points 44 and two first locking blocks 11 (the number of the first locking points 44 and the first locking blocks 11 may be three or more). The first locking points 44 correspond to the first locking blocks 11 one by one. The two first locking points 44 are respectively fixed on the upper and lower positions of one side of the transmission rod 43 close to the primary casement window frame 1. The two first locking blocks 11 are respectively fixed on the upper and lower positions of the primary casement window frame 1. The second locking point 45 is fixed to one side of the other transmission rod 43 close to the secondary frame 21. The second locking point 45 extends beyond the secondary frame 21. The secondary pane 3 is provided with a second locking block 31. The second locking block 31 cooperates with the second locking point 45 to lock or unlock the secondary pane 3. In order to make the secondary pane 3 more stable when the secondary pane 3 is closed, this embodiment has two second locking points 45 and two second locking blocks 31 (the number of the second locking points 45 and the second locking blocks 31 may be three or more). The second locking points 45 correspond to the second locking blocks 31 one by one. The two second locking points 45 are respectively fixed on the upper and lower positions of one side of the other transmission rod 43 close to the secondary frame 21. The two second locking blocks 31 are respectively fixed on the upper and lower positions of the secondary pane 3. When the handle 41 is not rotated, as shown in FIG. 6, both the first locking point 44 and the second locking point 45 are locked. When the handle 41 is rotated leftward or rightward, as shown in FIG. 7 and FIG. 8, the first locking point 44 is driven to unlock but the second locking point 45 remains locked, or the second locking point 45 and the first locking point 44 are unlocked.

The double-control single-handle handle lock of the present invention can be applied to other doors and windows other than the present invention (an inward-opening type casement window having outward-opening pane and screen) to realize a handle used for controlling opening and closing of two sashes (a primary sash and a secondary sash).

In addition to the above-mentioned integrated high-performance double-control single-handle handle lock structure, the handle lock 4 of the present invention may be other structures that can realize the opening and closing of the primary screen 2 and the secondary pane 3, such as a combined structure of two single-control single-handle locks.

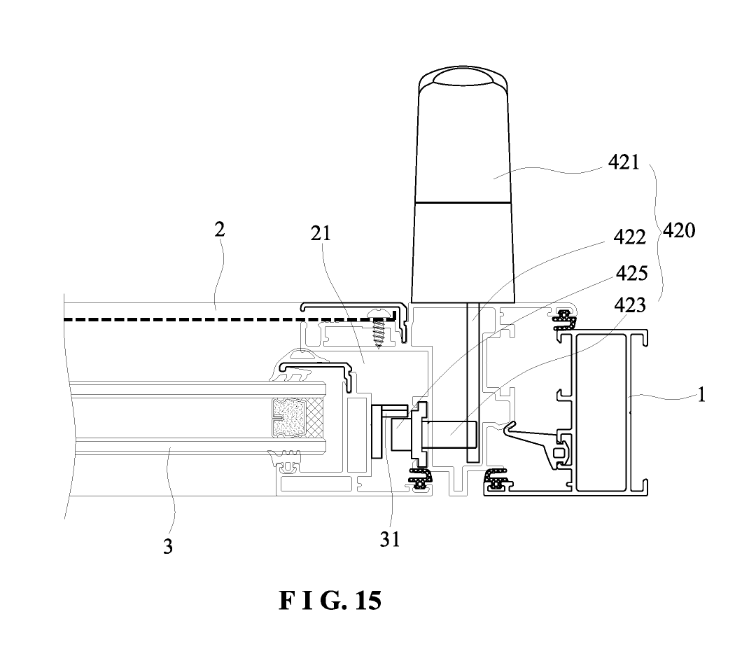

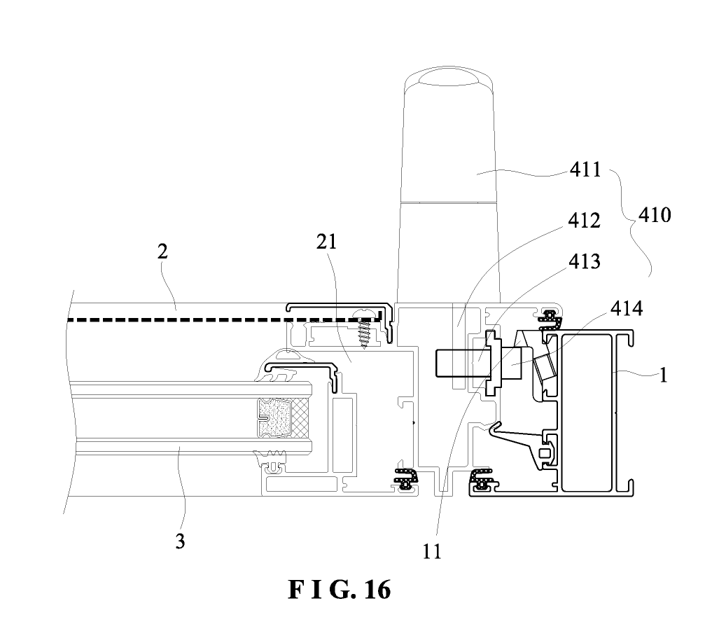

The handle lock 4, as shown in FIG. 15 and FIG. 16, has a single-control single-handle primary lock 410 and a single-control single-handle secondary lock 420. The primary lock 410 has a handle 411, a transmission shaft 412, a transmission rod 413, and a first locking point 414. The secondary lock 420 has a handle 421, a transmission shaft 422, a transmission rod 423, and a second lock point 425. The handle 411 of the primary lock 410 and the handle 421 of the secondary lock 420 are mounted at the inner side of the primary screen 2 and arranged at a high position and a lower position respectively. The transmission shaft 412 and the transmission rod 413 correspond to each other. The transmission shaft 422 and the transmission rod 423 correspond to each other and are installed on the primary screen 2. The handle 411 drives the transmission rod 413 to slide up and down through the transmission shaft 412. The handle 421 drives the transmission rod 423 to slide up and down through the transmission shaft 422. The first locking point 414 is fixed to one side of the transmission rod 413 of the primary lock 410 close to the primary casement window frame 1. The first locking point 414 extends beyond the primary screen 2. The primary casement window frame 1 is provided with a first locking block 11. The first locking block 11 cooperates with the first locking point 414 to lock or unlock the primary screen 2. The second locking point 425 is fixed to one side of the transmission rod 423 of the secondary lock 420 close to the secondary frame 21. The second locking point 425 extends beyond the secondary frame 21. The secondary pan 3 is provided with a second locking block 31. The second locking block 31 cooperates with the second locking point 425 to lock or unlock the secondary pane 3. When the two handles 411, 421 are not rotated, both the first locking point 414 and the second locking point 425 are locked. When the handle 411 of the primary lock 410 or the handle 421 of the secondary lock 420 is rotated, the first locking point 414 or the second locking point 425 is driven to unlock.

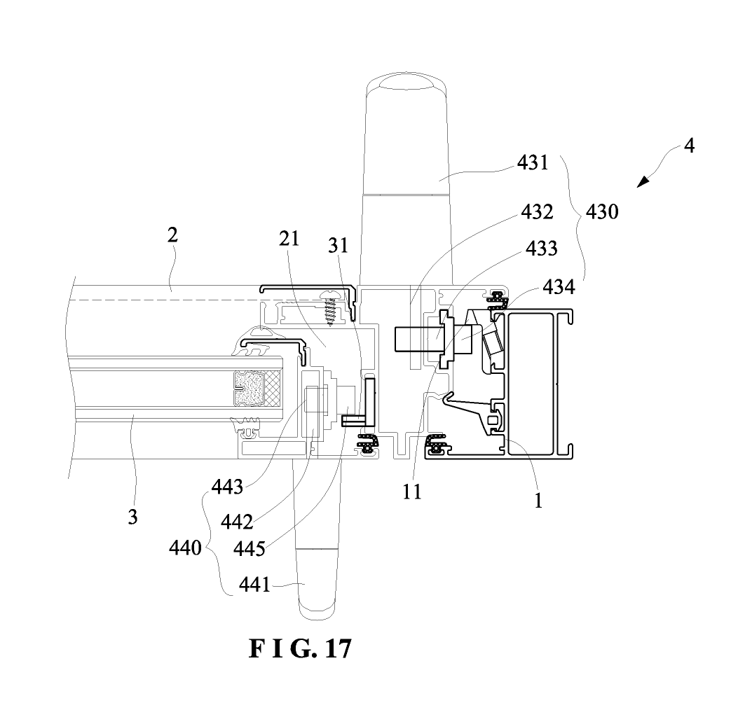

Alternatively, as shown in FIG. 17, the handle lock 4 has a single-control single-handle primary lock 430 and a single-control single-handle secondary lock 440. The primary lock 430 has a handle 431, a transmission shaft 432, a transmission rod 433, and a first locking point 434. The secondary lock 440 has a handle 441, a transmission shaft 442, a transmission rod 443, and a second locking point 445. The handle 431 of the primary lock 430 is installed at the inner side of the primary screen 2. The transmission shaft 432 and the transmission rod 433 are correspondingly installed on the primary screen 2. The handle 431 drives the transmission rod 433 to slide up and down through the transmission shaft 432. The first locking point 434 is fixed to one side of the transmission rod 433 close to the primary casement window frame 1. The first locking point 434 extends beyond the primary screen 2. The primary casement window frame 1 is provided with a first locking block 11. The first locking block 11 cooperates with the first locking point 434 to lock or unlock the primary screen 2. The handle 441 of the secondary lock 440 is installed at the outer side of the secondary pane 3. The transmission shaft 442 and the transmission rod 443 are correspondingly mounted on the secondary pane 3. The handle 441 drives the transmission rod 443 to slide up and down through the transmission shaft 442. The second locking point 445 is fixed to one side of the transmission rod 443 close to the secondary frame 21. The second locking point 445 extends beyond the secondary pane 3. The secondary frame 21 is provided with a second locking block 31. The second locking block 31 cooperates with the second locking point 445 to lock or unlock the secondary pane 3. When the two handles 431, 441 are not rotated, both the first locking point 434 and the second locking point 445 are locked. When the handle 431 of the primary lock 430 or the handle 441 of the secondary lock 440 is rotated, the first locking point 434 or the second locking point 445 is driven to unlock.

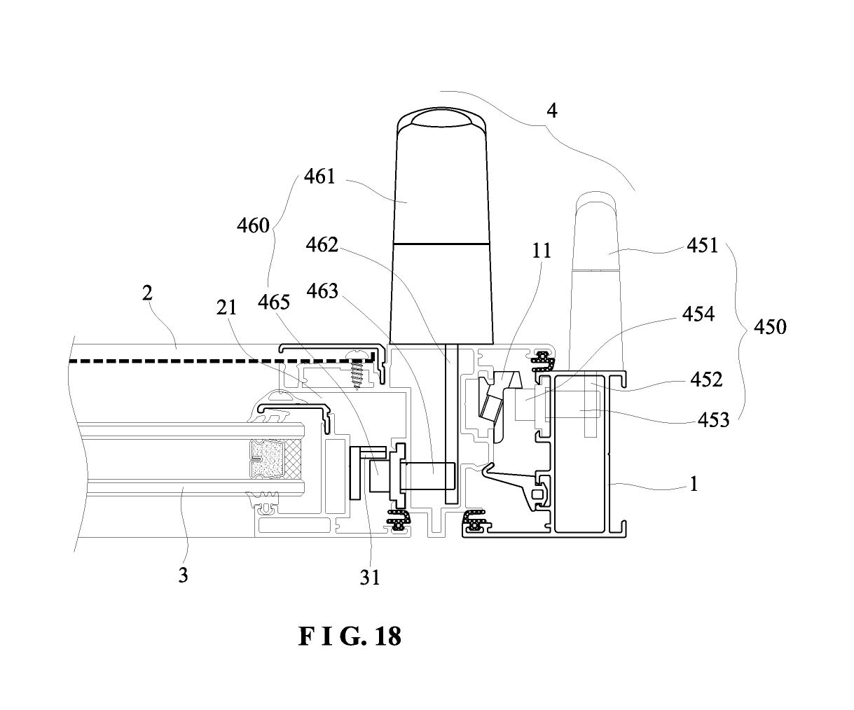

Alternatively, as shown in FIG. 18, the handle lock has a single-control single-handle primary lock 450 and a single-control single-handle secondary lock 460. The primary lock 450 has a handle 451, a transmission shaft 452, a transmission rod 453, and a first locking point 454. The secondary lock 460 has a handle 461, a transmission shaft 462, a transmission rod 463, and a second locking point 465. The handle 451 of the primary lock 450 is installed at the inner side of the primary casement window frame 1. The transmission shaft 452 and the transmission rod 453 are correspondingly installed on the primary casement window frame 1. The handle 451 drives the transmission rod 453 to slide up and down through the transmission shaft 452. The first locking point 454 is fixed to one side of the transmission rod 453 close to the primary screen 2. The first locking point 454 extends beyond the primary casement window frame 1. The primary screen 2 is provided with a first locking block 11. The first locking block 11 cooperates with the first locking point 454 to lock or unlock the primary screen 2. The handle 461 of the secondary lock 460 is installed at the inner side of the primary screen 2. The transmission shaft 462 and the transmission rod 463 are correspondingly mounted on the primary screen 2. The handle 461 drives the transmission rod 463 to slide up and down through the transmission shaft 462. The second locking point 465 is fixed to one side of the transmission rod 463 close to the secondary frame 21. The second locking point 465 extends beyond the primary screen 2. The secondary pane 3 is provided with a second locking block 31. The second locking block 31 cooperates with the second locking point 465 to lock or unlock the secondary pane 3. When the two handles 451, 461 are not rotated, both the first locking point 454 and the second locking point 465 are locked. When the handle 451 of the primary lock 450 or the handle 461 of the secondary lock 460 is rotated, the first locking point 454 or the second locking point 465 is driven to unlock.

As to the above-mentioned handle lock 4, both the handle lock of FIG. 6 to FIG. 8 and the handle lock of FIG. 15 to FIG. 16 are mounted on the primary screen 2. The former is a double-control single-handle high performance lock, and the latter is a combination of two single handles. The handle locks of FIG. 17 and FIG. 18 are also a combination of two single handles, but the handle lock of FIG. 17 is mounted on the primary screen 2 and the secondary pane 3 (both are on the sashes). The handle lock of FIG. 18 is mounted on the primary casement window frame 1 and the secondary frame 21 (both are on the frames).

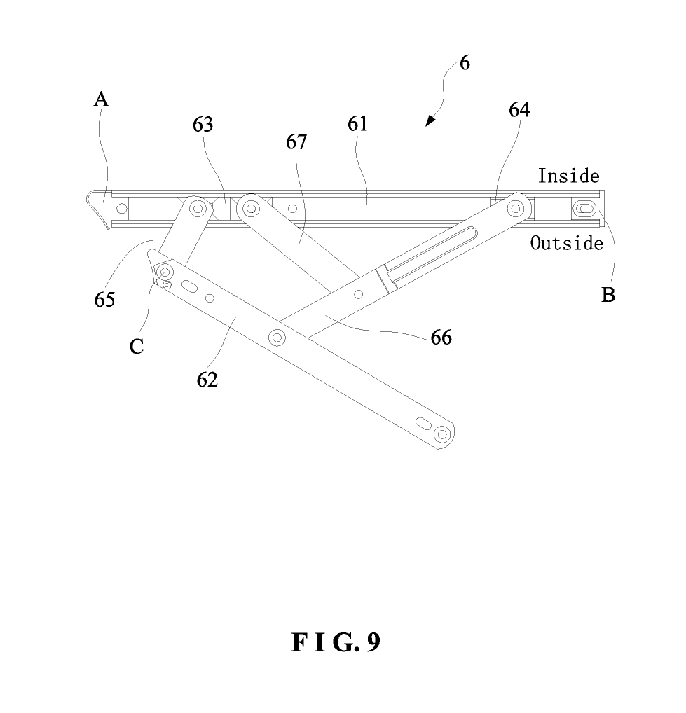

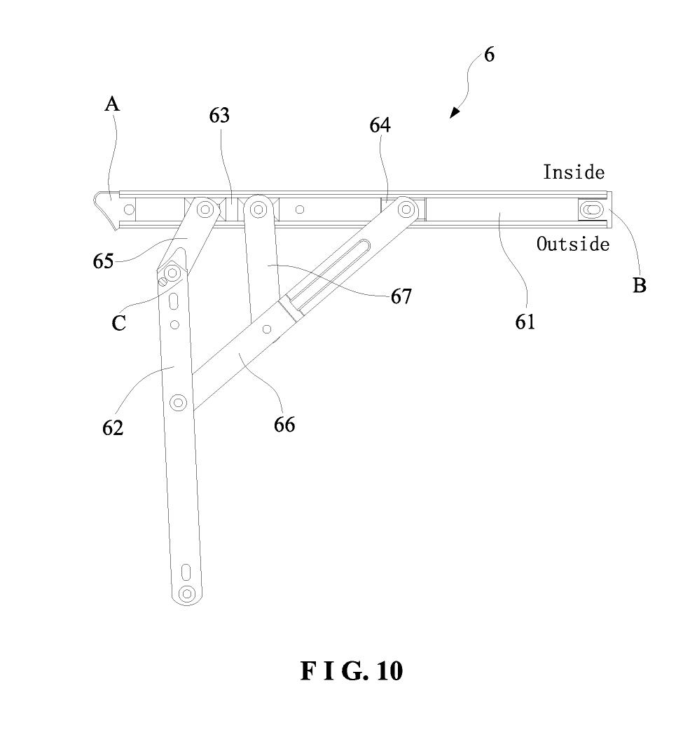

A further feature of the present invention is that the second hinge 6 may be a novel friction hinge. As shown in FIG. 9 to FIG. 10, the second hinge 6 has a hinge seat 61, a mounting rod 62, a fixing block 63, a slider 64, a first linkage rod 65, a second linkage rod 67, and a third linkage rod 66. The hinge seat 61 is fixedly mounted on the secondary frame 21. A head end A of the hinge seat 61 abuts against a non-opening end of the secondary frame 21. The fixing block 63 is fixed in the hinge seat 61 and is located at a position close to the head end A of the hinge seat 61. The slider 64 is slidably disposed at a distal end B of the hinge seat 61. The mounting rod 62 is mounted on the secondary pane 3. One end of each of the first linkage rod 65 and the second linkage rod 67 is pivotally connected to the fixing block 63. One end of the third linkage rod 66 is pivotally connected to the slider 64. Another end of the first linkage rod 65 is pivotally connected to a head end C of the mounting rod 62. Another end of the second linkage rod 67 is pivotally connected to the middle of the third linkage rod 66. Another end of the third linkage rod 66 is pivotally connected to the middle of the mounting rod 62.

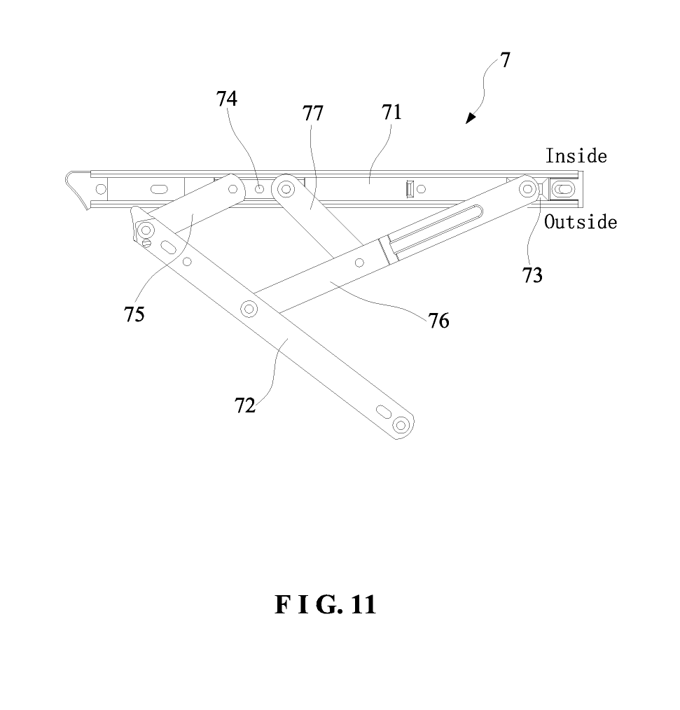

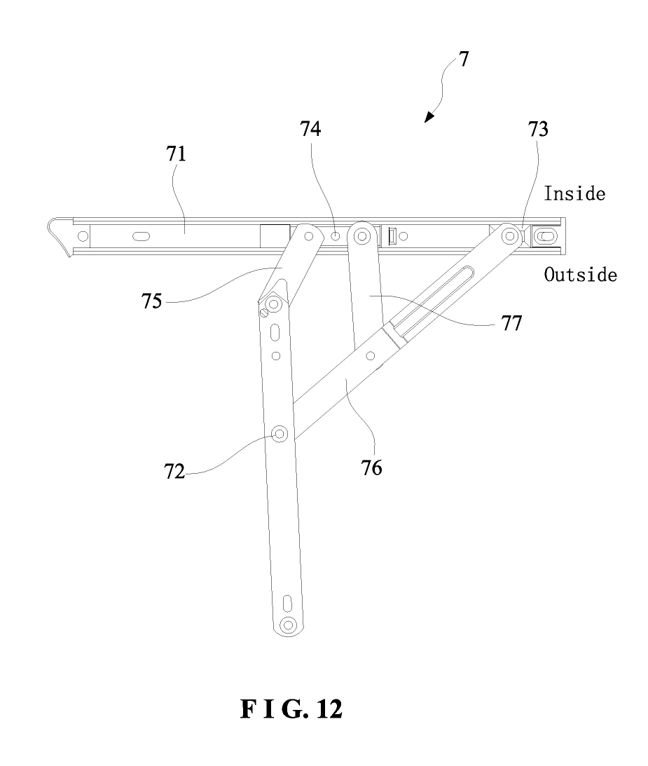

As shown in FIG. 11 and FIG. 12, a conventional friction hinge 7 has a hinge seat 71, a mounting rod 72, a fixing block 73, a slider 74, a linkage rod 75, a linkage rod 76, and a linkage rod 77. The structure of the conventional friction hinge 7 is different from that of the novel friction hinge 6 of the present invention. The conventional hinge seat 71 is fixedly mounted on the window frame. The fixing block 73 is fixed in the hinge seat 71 and located at the distal end of the hinge seat. The slider 74 is slidably disposed at a position close to the head end of the hinge seat 71. The mounting rod 72 is mounted on the sash. The linkage rod 75, the linkage rod 76 and the linkage rod 77 are pivotally connected to the fixing block, the slider and the assembly rod, respectively.

The main difference between the present invention and the conventional structure is that the positions of the fixing block and the slider are exchanged. In this way, the conventional structure is suitable for a common outward-opening casement window. After being opened, the window sash slides towards the open end. The gap between the non-opening end of the window sash and the window frame is big, which is equivalent to the slide distance of the slider 74. It is convenient to open the window outwardly for washing. However, in case the conventional friction hinge is applied to the inward-opening type casement window having outward-opening pane and screen of the present invention, when the primary screen 2 is opened inwardly and the secondary pane 3 is also opened and then the primary screen 2 is closed, which will result in the interference of the secondary pane 3 with the primary casement window frame 1. As to the novel friction hinge of the present invention, After being opened, the secondary pane 3 slides towards the open end by a short distance, and the gap between the non-opening end of the window sash and the window frame is small (only the fixed shaft distance), which avoids the interference of the secondary pane 3 with the primary casement window frame 1.

The novel friction hinge of the present invention may be applied to other doors and windows other than the present invention (an inward-opening type casement window having outward-opening pane and screen).

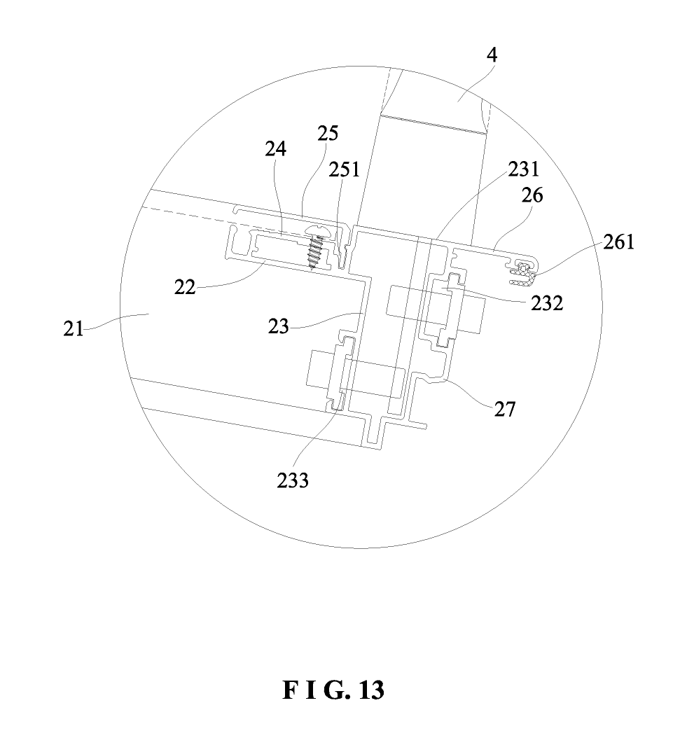

A further feature of the present invention is that the primary screen 2 has a T shape which is integrally formed or compositely formed, as shown in FIG. 13. The primary screen 2 has a primary horizontal frame 22, a primary vertical frame 23, and a stop flange 26. The primary horizontal frame 22 is located at an inner end of the primary vertical frame 23. The corner between the primary horizontal frame 22 and the primary vertical frame 23 is formed with the secondary frame 21 for mounting the secondary pane 3 to be opened outwardly. An inner side of the primary horizontal frame 22 is a screen mounting surface 24. A screen is fixed on the screen mounting surface 24 by screws. The screen mounting surface 24 is fastened with an engaging strip 25 by means of a groove 251 and insertion legs of the engaging strip 25. The engaging strip 25 is pressed against the edge of the screen to play a role in decoration and to protect the screen. Moreover, the engaging strip 25 is disposed at the inner side rather than the outer side, which can prevent the thief from removing the engaging strip 25 and the screws used to lock the screen to remove the anti-theft screen, thereby providing an anti-theft effect. The inner side of the primary vertical frame 23 is formed with a handle mounting portion 231. The inner end of the primary vertical frame 23 extends in a direction opposite to the primary horizontal frame 22 to form the stop flange 26 of the primary screen 2. A sealing groove of the stop flange 26 is provided with a sealing strip 261 to cooperate with the primary casement window frame 1. The stop flange 26 and the sealing strip 261 cooperate with the primary casement window frame 1 to ensure the airtightness when the primary screen 2 is closed. The primary vertical frame 23 has a chamber for mounting the transmission shaft and the transmission rod of the handle lock 4. One side surface of the primary vertical frame 23, close to the primary casement window frame 1, and another side surface of the primary vertical frame 23, close to the secondary frame 21, are formed with mounting troughs 232, 233 for mounting the first and second locking points or the first and second locking blocks, respectively. The side surface of the primary vertical frame 23, close to the primary casement window frame 1, is further formed with another stop flange 27 to cooperate with a sealing strip 12 of the primary casement window frame 1.

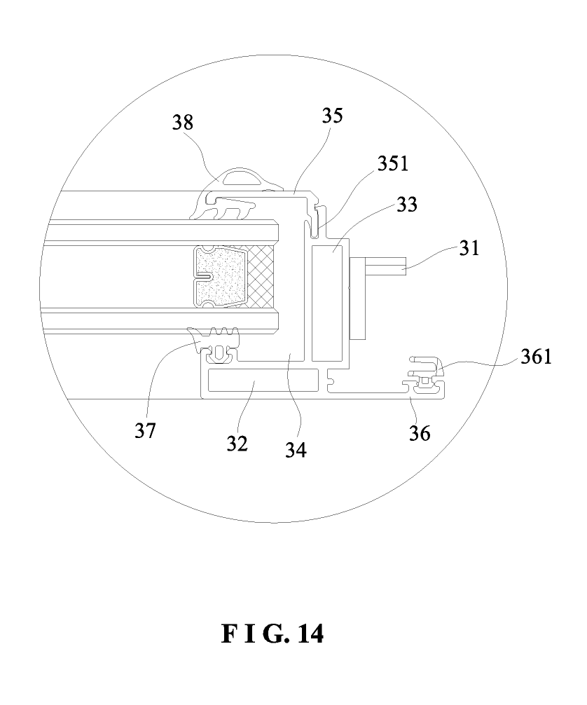

The secondary pane 3 has a T shape which is integrally formed or compositely formed, as shown in FIG. 14. The secondary pane 3 has a secondary horizontal frame 32, a secondary vertical frame 33, and a stop flange 36. The secondary horizontal frame 32 is located at an outer inner end of the secondary vertical frame 33. The corner between the secondary horizontal frame 32 and the secondary vertical frame 33 is formed with a glass frame 34 for mounting the glass of the secondary pane 3. An inner end of the secondary vertical frame 33 is provided with a glass fixing plate 35 corresponding to the glass frame 34 by means of a groove 351 and insertion legs of the glass fixing plate 35. The glass of the secondary pane 3 is mounted between the glass frame 34 and the glass fixing plate 35 by means of rubber strips 37, 34. The rubber strip 37 is mounted in a sealing groove of the secondary horizontal frame 32 corresponding to the glass frame. The rubber strip 38 is a double-sided rubber strip to clamp the end of the glass fixing plate 35. One side of the rubber strip 38 is mated with the glass of the secondary pane 3, and the other side is mated with the screen of the primary screen 2. An outer end of the secondary vertical frame 33 extends in a direction opposite to the secondary horizontal frame 32 to form the stop flange 36 of the secondary pane 3 to cooperate with the secondary frame 21. A sealing groove of the stop flange 36 is provided with a sealing strip 361 to cooperate with the secondary frame 21.

When in use, as shown in FIG. 6, the handle 41 is not rotated in the initial state. The first locking point 44 cooperates with the first locking block 11 to be locked so that the primary screen 2 is closed. The second locking point 45 cooperates with the second locking block 31 to be locked so that the secondary pane 3 is closed. At this time, as shown in FIG. 1, the entire window (the primary screen 2 and the secondary pane 3) is in a locked state.

As shown in FIG. 7, the handle 41 is rotated rightward. The handle 41 drives the transmission rod 43 to ascend through the transmission shaft 42. The first locking point 44 and the second locking point 45 also ascend. The first locking point 44 is separated from the first locking block 11 to unlock so that the primary screen 2 can be opened. However, the second locking point 45 and the second locking block 31 are still locked so that the secondary pane 3 is still closed. At this time, as shown in FIG. 2, the entire window (the primary screen 2 and the secondary pane 3) is in an inward-opening state.

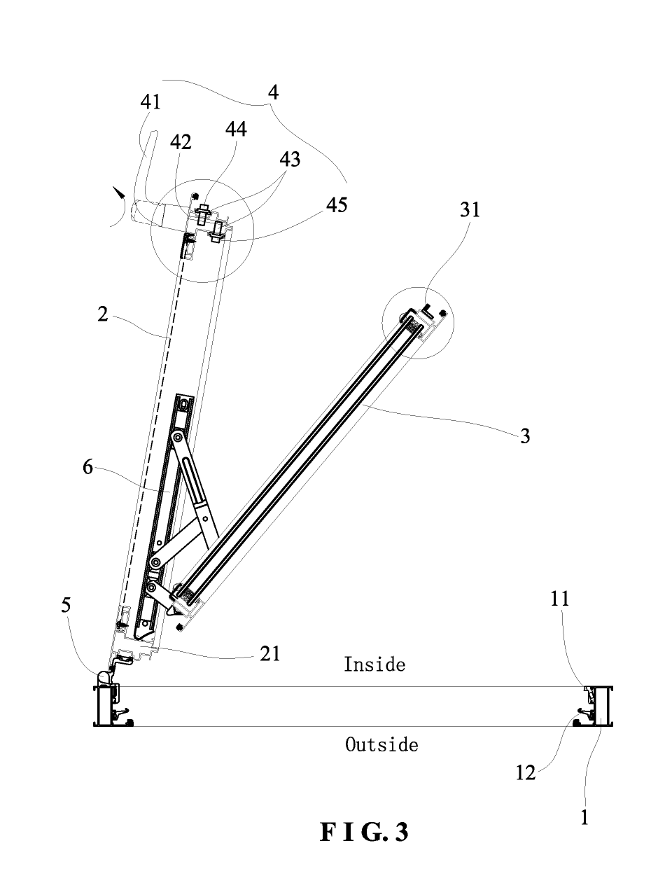

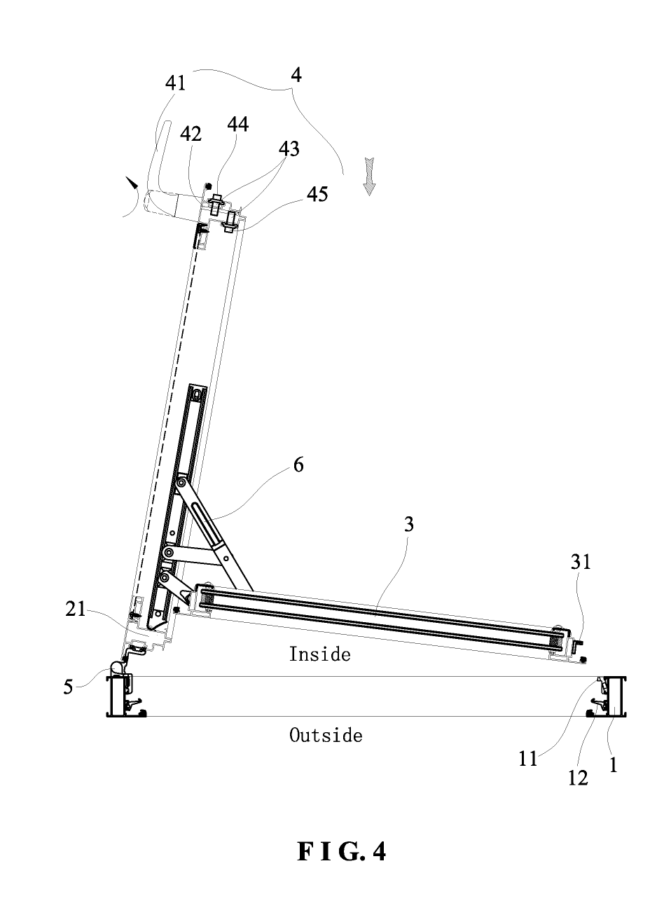

In the state shown in FIG. 2, as shown in FIG. 8, the handle 41 is rotated leftward. The handle 41 drives the transmission rod 43 to descend through the transmission shaft 42. The first locking point 44 and the second locking point 45 also descend. The second locking point 45 is separated from the second locking block 31 to unlock so that the secondary pane 3 can be opened. However, the primary screen 2 is still in an inward-opening state, as shown in FIG. 3 and FIG. 4. In this state, the screen and the glass can be cleaned easily and safely.

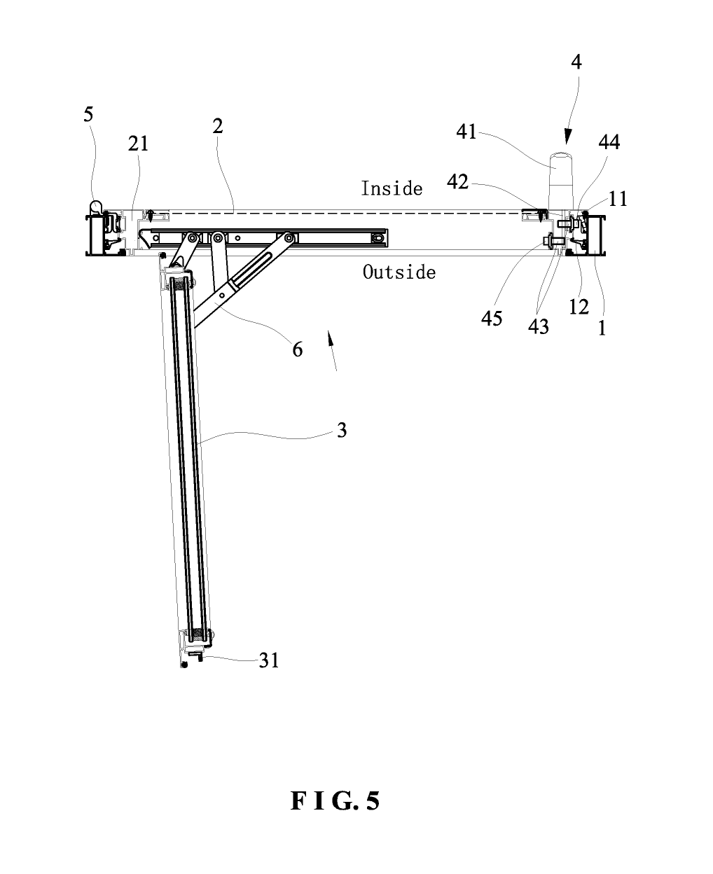

In the state shown in FIG. 1, as shown in FIG. 8, the handle 41 is rotated leftward. The handle 41 drives the transmission rod 43 to descend through the transmission shaft 42. The first locking point 44 and the second locking point 45 also descend. The second locking point 45 is separated from the second locking block 31 to unlock so that the secondary pane 3 can be opened. Meanwhile, the first locking point 44 and the first locking block 11 are unlocked as shown in FIG. 5, and then the primary screen 2 is closed. The handle 41 is rotated rightward to the initial state to lock the first locking point 44 and the first locking block 11. In this state, the ventilation effect and the anti-mosquito and anti-theft effects can be achieved.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An inward-opening type casement window having outward-opening pane and screen, comprising a primary casement window frame, a primary screen, a secondary pane and a handle lock, the primary screen being installed in the primary casement window frame via a first hinge so as to open inwardly, the primary screen being formed with a secondary frame, the secondary pane being installed in the secondary frame via a second hinge so as to open outwardly, the handle lock being installed between the primary screen and the primary casement window frame and between the secondary pane and the secondary frame, the handle lock being used to control opening and closing of the primary screen and the secondary pane, thereby enabling the entire casement window to be closed, or the secondary pane to be opened inwardly along with the primary screen, or the secondary pane to be separated from the primary screen and opened outwardly, or the secondary pane in an open state to be opened outwardly upon closing of the primary screen.

2. The inward-opening type casement window having outward-opening pane and screen as claimed in claim 1, wherein the handle lock is a double-control single-handle handle lock, the handle lock has a handle, a transmission shaft, two transmission rods, a first locking point and a second locking point, the handle is mounted at an inner side of the primary screen, the transmission shaft and the transmission rods are mounted on the primary screen, the handle drives the transmission rods to slide up and down through the transmission shaft, the first locking point is fixed to one side of one of the transmission rods close to the primary casement window frame, the first locking point extends beyond the primary screen, the primary casement window frame is provided with a first locking block, the first locking block cooperates with the first locking point to lock or unlock the primary screen, the second locking point is fixed to one side of the other transmission rod close to the secondary frame, the second locking point extends beyond the secondary frame, the secondary pane is provided with a second locking block, the second locking block cooperates with the second locking point to lock or unlock the secondary pane, when the handle is not rotated, the first locking point and the second locking point are locked, when the handle is rotated leftward or rightward, the first locking point is driven to unlock but the second locking point remains locked or the second locking point and the first locking point are unlocked.

3. The inward-opening type casement window having outward-opening pane and screen as claimed in claim 1, wherein the handle lock has a single-control single-handle primary lock and a single-control single-handle secondary lock, the primary lock and the secondary lock each have a handle, a transmission shaft, a transmission rod, and a first locking point or a second locking point, the handles of the primary lock and the secondary lock are mounted at an inner side of the primary screen and arranged at a high position and a lower position respectively, the two transmission shafts and the two transmission rods of the primary lock and the secondary lock are correspondingly installed on the primary screen, the handle drives the corresponding transmission rod to slide up and down through the corresponding transmission shaft, the first locking point is fixed to one side of the transmission rod of the primary lock close to the primary casement window frame, the first locking point extends beyond the primary screen, the primary casement window frame is provided with a first locking block, the first locking block cooperates with the first locking point to lock or unlock the primary screen, the second locking point is fixed to one side of the transmission rod of the secondary lock close to the secondary frame, the second locking point extends beyond the secondary frame, the secondary pane is provided with a second locking block, the second locking block cooperates with the second locking point to lock or unlock the secondary pane, when the two handles of the primary lock and the secondary lock are not rotated, the first locking point and the second locking point are locked, when the handle of the primary lock or the handle of the secondary lock is rotated leftward or rightward, the first locking point or the second locking point is driven to unlock;
or, the handle lock has a single-control single-handle primary lock and a single-control single-handle secondary lock, the primary lock and the secondary lock each have a handle, a transmission shaft, a transmission rod, and a first locking point or a second locking point, the handle of the primary lock is installed at an inner side of the primary screen, the transmission shaft and the transmission rod of the primary lock are correspondingly installed on the primary screen, the handle of the primary lock drives the corresponding transmission rod to slide up and down through the corresponding transmission shaft, the first locking point is fixed to one side of the transmission rod of the primary lock close to the primary casement window frame, the first locking point extends beyond the primary screen, the primary casement window frame is provided with a first locking block, the first locking block cooperates with the first locking point to lock or unlock the primary screen, the handle of the secondary lock is installed at an outer side of the secondary pane, the transmission shaft and the transmission rod of the secondary lock are correspondingly mounted on the secondary pane, the handle drives the corresponding transmission rod to slide up and down through the corresponding transmission shaft, the second locking point is fixed to one side of the transmission rod of the secondary lock close to the secondary frame, the second locking point extends beyond the secondary pane, the secondary frame is provided with a second locking block, the second locking block cooperates with the second locking point to lock or unlock the secondary pane, when the two handles of the primary lock and the secondary lock are not rotated, the first locking point and the second locking point are locked, when the handle of the primary lock or the handle of the secondary lock is rotated leftward or rightward, the first locking point or the second locking point is driven to unlock;
or, the handle lock has a single-control single-handle primary lock and a single-control single-handle secondary lock, the primary lock and the secondary lock each have a handle, a transmission shaft, a transmission rod, and a first locking point or a second locking point, the handle of the primary lock is installed at an inner side of the primary casement window frame, the transmission shaft and the transmission rod of the primary lock are correspondingly installed on the primary casement window frame, the handle of the primary lock drives the corresponding transmission rod to slide up and down through the corresponding transmission shaft, the first locking point is fixed to one side of the transmission rod of the primary lock close to the primary screen, the first locking point extends beyond the primary casement window frame, the primary screen is provided with a first locking block, the first locking block cooperates with the first locking point to lock or unlock the primary screen, the handle of the secondary lock is installed at an inner side of the primary screen, the transmission shaft and the transmission rod of the secondary lock are correspondingly mounted on the primary screen, the handle of the secondary lock drives the corresponding transmission rod to slide up and down through the corresponding transmission shaft, the second locking point is fixed to one side of the transmission rod of the secondary lock close to the secondary frame, the second locking point extends beyond the primary screen, the secondary pane is provided with a second locking block, the second locking block cooperates with the second locking point to lock or unlock the secondary pane, when the two handles of the primary lock and the secondary lock are not rotated, the first locking point and the second locking point are locked, when the handle of the primary lock or the handle of the secondary lock is rotated leftward or rightward, the first locking point or the second locking point is driven to unlock.

4. The inward-opening type casement window having outward-opening pane and screen as claimed in claim 2 or 3, wherein the primary screen has a T shape which is integrally formed or compositely formed, the primary screen has a primary horizontal frame, a primary vertical frame and a stop flange, the primary horizontal frame is located at an inner end of the primary vertical frame, a corner between the primary horizontal frame and the primary vertical frame is formed with the secondary frame for mounting the secondary pane in an outward-opening manner, an inner side of the primary horizontal frame is a screen mounting surface, the screen mounting surface is provided with an engaging strip, an inner side of the primary vertical frame is formed with a handle mounting portion, the inner end of the primary vertical frame extends in a direction opposite to the primary horizontal frame to form the stop flange of the primary screen to cooperate with the primary casement window frame, the primary vertical frame has a chamber for mounting the transmission shaft and the transmission rod of the handle lock, one side surface of the primary vertical frame, close to the primary casement window frame, and another side surface of the primary vertical frame, close to the secondary frame, are formed with mounting troughs for mounting the first and second locking points or the first and second locking blocks respectively, and the side surface of the primary vertical frame, close to the primary casement window frame, is further formed with another stop flange to cooperate with a sealing strip of the primary casement window frame.

5. The inward-opening type casement window having outward-opening pane and screen as claimed in claim 2 or 3, wherein the first locking point and the first locking block each have two or more, the first locking points correspond to the first locking blocks one by one; the second locking point and the second locking block each have two or more, and the second locking points correspond to the second locking blocks one by one.

6. The inward-opening type casement window having outward-opening pane and screen as claimed in claim 1, wherein the first hinge is a butt hinge or a pie-cut corner hinge; the second hinge is a butt hinge, a pie-cut corner hinge or a novel friction hinge; the primary casement window frame, the primary screen and the secondary pane is made of aluminum alloy, plastics, wood, steel, glass fiber reinforced plastics (FRP) or a composite thereof;
and the primary screen is made of plastics, stainless steel or other material.

7. The inward-opening type casement window having outward-opening pane and screen as claimed in claim 1, wherein the second hinge is a novel friction hinge, the second hinge has a hinge seat, a mounting rod, a fixing block, a slider, a first linkage rod, a second linkage rod and a third linkage rod, the hinge seat is mounted on the secondary frame, a head end of the hinge seat abuts against a non-opening end of the secondary frame, the fixing block is fixed in the hinge seat and is located at a position close to the head end of the hinge seat, the slider is slidably disposed at a distal end of the hinge seat, the mounting rod is mounted on the secondary pane, one end of each of the first linkage rod and the second linkage rod is pivotally connected to the fixing block, one end of the third linkage rod is pivotally connected to the slider, another end of the first linkage rod is pivotally connected to a head end of the mounting rod, and another end of the second linkage rod is pivotally connected to a middle of the third linkage rod, another end of the third linkage rod is pivotally connected to a middle of the mounting rod.

8. A double-control single-handle handle lock, comprising a handle, a transmission shaft, two transmission rods, a first locking point and a second locking point, the handle is mounted at an inner side of a primary screen, the transmission shaft and the transmission rods are mounted on the primary screen, the handle drives the transmission rods to slide up and down through the transmission shaft, the first locking point is fixed to one side of one of the transmission rods close to a primary casement window frame, the first locking point extends beyond the primary screen, the primary casement window frame is provided with a first locking block, the first locking block cooperates with the first locking point to lock or unlock the primary screen, the second locking point is fixed to one side of the other transmission rod close to a secondary frame, the second locking point extends beyond the secondary frame, a secondary pane is provided with a second locking block, the second locking block cooperates with the second locking point to lock or unlock the secondary pane, when the handle is not rotated, the first locking point and the second locking point are locked, when the handle is rotated leftward or rightward, the first locking point is driven to unlock but the second locking point remains locked or the second locking point and the first locking point are unlocked.

9. A novel friction hinge, comprising a hinge seat, a mounting rod, a fixing block, a slider, a first linkage rod, a second linkage rod and a third linkage rod, the hinge seat being mounted on a secondary frame, a head end of the hinge seat abutting against a non-opening end of the secondary frame, the fixing block being fixed in the hinge seat and located at a position close to the head end of the hinge seat, the slider being slidably disposed at a distal end of the hinge seat, the mounting rod is mounted on a secondary pane, one end of each of the first linkage rod and the second linkage rod being pivotally connected to the fixing block, one end of the third linkage rod being pivotally connected to the slider, another end of the first linkage rod being pivotally connected to a head end of the mounting rod, and another end of the second linkage rod being pivotally connected to a middle of the third linkage rod, another end of the third linkage rod being pivotally connected to a middle of the mounting rod.

10. An inward-opening type casement window having outward-opening pane and screen, comprising a primary screen, the primary screen having a T shape which is integrally formed or compositely formed, the primary screen having a primary horizontal frame, a primary vertical frame and a stop flange, the primary horizontal frame being located at an inner end of the primary vertical frame, a corner between the primary horizontal frame and the primary vertical frame being formed with a secondary frame for mounting a secondary pane in an outward-opening manner, an inner side of the primary horizontal frame being a screen mounting surface, the screen mounting surface being provided with an engaging strip, an inner side of the primary vertical frame being formed with a handle mounting portion, the inner end of the primary vertical frame extending in a direction opposite to the primary horizontal frame to form the stop flange of the primary screen to cooperate with a primary casement window frame, the primary vertical frame having a chamber for mounting a transmission shaft and a transmission rod of a handle lock, one side surface of the primary vertical frame, close to the primary casement window frame, and another side surface of the primary vertical frame, close to the secondary frame, being formed with mounting troughs for mounting first and second locking points or first and second locking blocks respectively, and the side surface of the primary vertical frame, close to the primary casement window frame, being further formed with another stop flange to cooperate with a sealing strip of the primary casement window frame.
